(19) United States
(12) Patent Application Publication
(10) Pub. No.: US 2016/0045825 A1
(43) Pub. Date: Feb. 18, 2016

(54) SYSTEM FOR MANAGING DIRECT CHALLENGES BETWEEN USERS IN FANTASY SPORTS AND OTHER GAMES

(71) Applicant: ZCO, LLC, Minneapolis, MN (US)

(72) Inventors: Daniel G. Kehoe, Atlanta, GA (US); David Sanchez Escobar, Bogata (CO); Brian O'Rourke, Monroe, GA (US)

(21) Appl. No.: 14/927,445

(22) Filed: Oct. 29, 2015

Related U.S. Application Data
(63) Continuation of application No. PCT/US2014/036241, filed on Apr. 30, 2014.
(60) Provisional application No. 61/818,028, filed on May 1, 2013.
(60) Provisional application No. 61/936,501, filed on Feb. 6, 2014.

(51) Int. Cl. A63F 13/31; A63F 13/44; A63F 13/46; A63F 13/60

(52) U.S. Cl. CPC A63F 13/31; A63F 13/60; A63F 13/44; A63F 13/46

(57) ABSTRACT

Interactive systems and methods for creating game and game-like applications, including a direct challenge application for building a head-to-head challenge between users, are presented. A system for building and managing a plurality of direct challenges includes an application services interface, a plurality of user interfaces, a challenge application, and a plurality of external data services for tracking the progress and player performance during real-world events, such as sporting events. Also disclosed is a system and methods allowing a user to change or modify their fantasy player lineup during the progress of a live action sporting event.

### PRIORITY

The present application is a continuation of, and claims priority benefit of, PCT/US2014/036241, filed Apr. 30, 2014, which claims the benefit of and priority to (1) U.S. Provisional Application 61/936,501, filed Feb. 6, 2014, and (2) U.S. Provisional Application 61/818,028, filed May 1, 2013. All of the foregoing applications are hereby incorporated herein by reference in their entireties.

### FIELD

Certain disclosed embodiments relate to the field of fantasy sports systems and related methods.

### BACKGROUND

Currently available games and game-like applications, including fantasy sports systems, monitor and record individual player performance as part of scoring the competitions. Because results and scores are driven, in part, by individual player performance, many users follow individual players very closely. Many users strongly desire a way to more actively use and apply their knowledge of individual players, in contests with other users, within the context of games such as fantasy sports. Thus, there is a need in the art for improved game systems and contest applications that allow users to compete with others in contests that are based, at least in part, on individual player performance.

### SUMMARY

In some embodiments, a system for managing a plurality of direct challenges between users of a game application includes: an application services interface comprising a database and an external data reader in communication with a plurality of external data services; a plurality of user interfaces to facilitate access to the application services interface; and a challenge application comprising a non-transitory computer-readable medium containing program instructions for managing a plurality of direct challenges between users, and one or more processors of a computer system coupled to the non-transitory computer-readable medium for executing the program instructions to: (a) receive a first competitor selected by the first user for participation in a first direct challenge; (b) receive a second competitor to serve as a rival of the first competitor in the first direct challenge; (c) receive a performance parameter for the first direct challenge; (d) receive a time period for the first direct challenge; (e) receive an acceptance from a second user and, in response, deploy the first direct challenge; (f) instruct the external data reader to collect a first set of actual performance data for the first competitor during the time period, and a second set of actual performance data for the second competitor during the time period, from at least one of the plurality of external data services; (g) calculate a score for the first direct challenge, wherein the score is based on a comparison of the first set of actual performance data and the second set of actual performance data; (h) report the score to the first user; and (i) store the score in the database.

The one or more processors may further execute the program instructions to: present the first direct challenge to the second user on a display; provide the second user with an option to submit a response consisting of an indicator selected from the group consisting of accept, decline, and counteroffer; receive the response from the second user; and in response to receiving the response equal to counteroffer, present one or more attributes of the first direct challenge to the second user for review and modification.

The first competitor may comprise a first team, and the second competitor may comprise a second team.

The first competitor may comprise a first group of two or more, and the second competitor may comprise a second group of two or more, wherein the second group has the same number of participants as the first group.

The one or more processors may further execute the program instructions to: receive a selection of a first non-currency wager related to the first direct challenge; and apply the wager to the first direct challenge based on the score.

The application services interface may further comprise a challenge reporting tool for displaying a plurality of direct challenges, arranged by date, to one or more of the fellow users.

The application services interface may further comprise a social reporting engine for collecting and storing user data in a user database, the user data comprising demographic facts and game-play behavior, for at least a first subset of the fellow users during a predetermined subset of interactions with the application services interface.

In other embodiments, an interactive system for a plurality of game-like activities includes: (a) a content management system comprising a plurality of game templates, a game content database in communication with a plurality of external data services; (b) a plurality of application services, in communication with the content management system, comprising one or more game-like applications; and (c) one or more user interfaces to facilitate access to the plurality of application services for a plurality of users, wherein the one or more game-like applications comprises a challenge application.

The interactive system may further include a social reporting engine, in communication with the content management system, for collecting and storing user data in a user database, the user data comprising demographic facts and game-play behavior, for at least a first subset of the plurality of users during a predetermined subset of interactions with the plurality of application services.

### BRIEF DESCRIPTION OF THE DRAWINGS

Features of the various embodiments disclosed will become more apparent in the detailed description, in which reference is made to the appended drawing, wherein:

FIG. 1 is a schematic illustration of a system for game creation and management, shown in one exemplary platform architecture, according to various embodiments.

FIG. 2 is a schematic illustration of a system for managing head-to-head challenges in fantasy sports or other applications, according to various embodiments.

FIG. 3 is a sample display of content in a system for building and managing direct challenges, according to various embodiments.

FIG. 4 through FIG. 13 is a series of sample displays, with interactive user interfaces, for a system for building and managing direct challenges, according to various embodiments.

FIG. 14 is a sample display of a list of direct challenges, according to various embodiments.

FIGS. 15 through 32 comprise a series of interactive user interfaces on a display for executing the roster management system, according to various embodiments.

Corresponding reference numbers indicate corresponding parts or elements throughout the several views of the drawing.

### DETAILED DESCRIPTION

The present systems and apparatuses and methods are understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

Like parts are marked throughout the following description and drawings with the same reference numerals. The drawings may not be to scale and certain features may be shown exaggerated in scale or in somewhat schematic format in the interest of clarity, conciseness, and to convey information.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to a component can include two or more such components unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

### Games

As used herein, the term games refers to activities undertaken for play or amusement, as well as game-like interactive activities that are used to facilitate the pursuit of a specific object or purpose. In a broad sense, the games described herein enable users to interact with both the game content itself and with game-related insertions or requests (sometimes referred as calls to action). As described, the games and game-like interactive systems herein, including the game systems for creating supersets of games, provide deeper engagement between the user and the game. As used herein, user engagement refers to the frequency of play, duration of play, and the depth of interaction with game content and/or calls to action. Deeper user engagement increases the value of games, especially in the commercial context. Games created and managed by the game system described herein are lower in cost, faster to deploy, and easier to manage than those produced by existing game systems.

### System

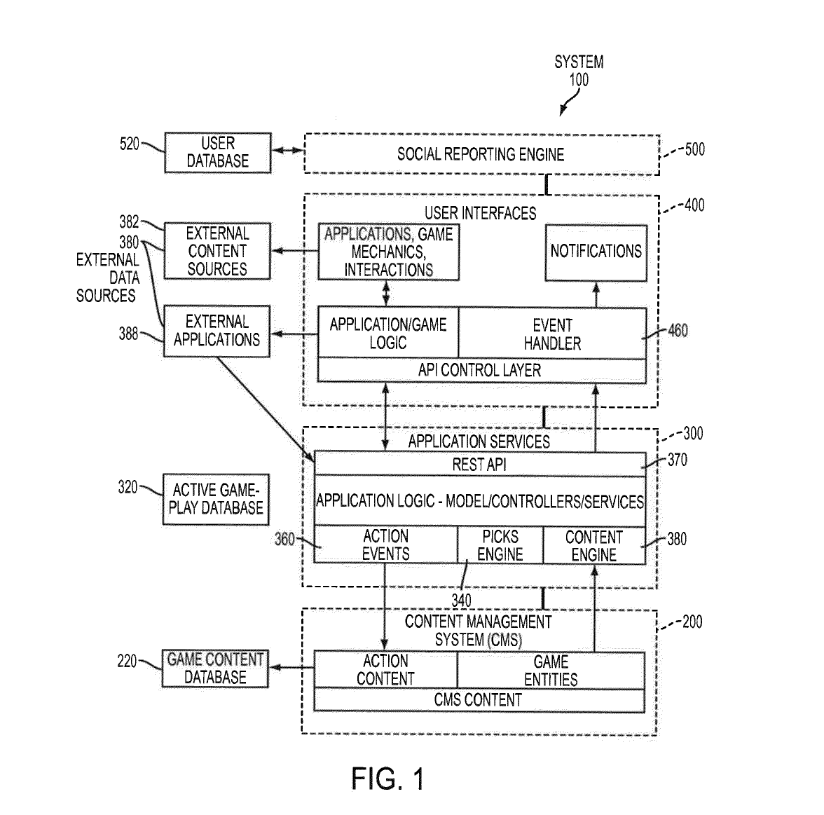

FIG. 1 is a schematic illustration of a system 100 for game creation and management, according to particular embodiments. As shown, the system 100 may include a variety of elements in communication with one another, including a content management system 200, application services 300, user interfaces 400, and a social reporting engine 500. The system 100 may also include a game content database 220, an active game-play database 320, a user database 520, and external data sources 380. The external data sources 380 may include external content sources 382 and external applications 388.

FIG. 1 also illustrates a system platform architecture, according to various embodiments. The game systems and methods described herein may be provided using a self-service platform that facilitates the creation and management of games through a friendly set of user interfaces 400. The system architecture, according to various embodiments, may include the components and modules illustrated in FIG. 1.

### Social Reporting Engine

In another aspect, the game system 100, according to particular embodiments, is designed to facilitate the creation and play of a superset of games by providing a wide selection of game types and categories and by actively collecting user data across the entire superset of games using a module referred to as the Social Reporting Engine 500. The Social Reporting Engine 500, according to particular embodiments, gathers user data including user behavior during registration and use of the game system, during game play, during related interactions (such as answering surveys and responding to other types of calls to action), and during social-media actions (entering likes, sharing content, and the like)—across multiple games, over an extended period of time, resulting in the population and updating of potentially millions of user data profiles, which may be stored in a user database 520.

User data includes initial profile data provided voluntarily by the user, typically beginning with the sharing of information already contained in a Facebook profile, Twitter account, Foursquare history, or other integrated third-party application. The game system provider may also gather user data by query or otherwise at any time during membership. User data also includes game performance, by specific game played; including, for example, whether the user makes accurate predictions in a particular sport, and whether the user consistently likes or prefers a certain product, service, or company. In a preferred embodiment, user data will be aggregated in order to derive business intelligence and other useful information in a manner that does not sell or disclose personally-identifiable information. The user data may be provided in an aggregated or anonymized format; however, such user data is valuable because the user data collected and stored by the game system of the present invention includes a variety of useful demographic information, combined with a history of user behavior within the game system and related activities, as described herein. This combination of demographic information and actual user behavior contributes to the value of the user data collected and stored by the game system.

### Head-to-Head Challenges

The systems and methods described herein include a head-to-head challenge application sometimes referred to as Mano e Mano. A head-to-head challenge as used herein refers to a direct challenge between two individual users of an application such as a game or fantasy sports application.

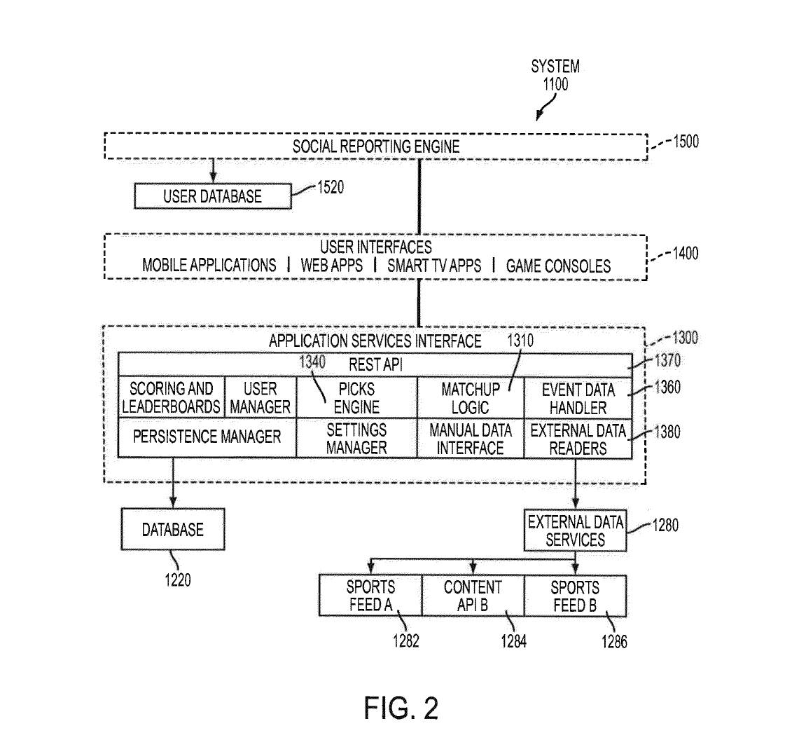

According to particular embodiments, FIG. 2 is a schematic illustration of a challenge system 1100 for generating and managing a plurality of direct challenges between users of a game application. As shown, the challenge system 1100 may include a variety of elements in communication with one another, including an application services interface 1300, a plurality of user interfaces 1400, and a social reporting engine 1500. The challenge system 1100 may also include a database 1220, a user database 1520, and one or more external data services 1280. The external data services 1280 may include a sports feed A 1282, a content API B 1284, and a sports feed B 1286, for example.

In alternative embodiments, the challenge system 1100 may include a content management system similar to the one depicted in FIG. 1.

The application services interface 1300, as shown, may include a REST API 1370 to make calls to independent modules. REST (Representational State Transfer) is a style of software architecture for distributed systems, such as the internet. The REST API 370 allows for improved scalability, control of components and related rules, development of interfaces, and the deployment of additional components.

At the logic level, the application services interface 1300 in particular embodiments, as shown, includes modules for Scoring and Leaderboards, a User Manager, Picks Engine 1340, Matchup Logic 1310, and an Event Data Handler 1360. At the data level, the application services interface 1300 in particular embodiments, as shown, includes a Persistence Manger, Settings Manager, Manual Data Interface, and one or more External Data Readers 1380.

The challenge application, according to particular embodiments, may be implemented using a programmed computer. A direct challenge may be a contest between competitors or rivals (or perceived rivals) in any of a variety of fields of endeavor such as sports, politics, or entertainment. The challenge may be constructed in the following general format: “[First Competitor] will [outperform according to this performance parameter] the [Second Competitor] during [this event or time period].” The outcome or score of the challenge may be determined by comparing each competitor's actual performance; for example, in real-world games or competitions. The challenge application allows users to build each element of a direct challenge using an interface that is dynamic and user friendly. The challenge application may include any or all of the features and functions of the game systems described herein. For example, a challenge application may include access to game content or other data accessible by the system; for example, a photograph of one or both competitors.

In the context of a bracket game, the First Competitor and/or Second Competitor may be a player selected from any of the teams competing in the bracket. The performance parameter may be score more points. The time period may be during the second period of play in each respective Competitors+first game of the tournament. As illustrated in FIG. 2, schematically, the application services interface 1300 may include matchup logic 1310. Matchup logic 1310, according to particular embodiments, may include rules, logic, limits, and standard representations for the matchup data. The matchup data for the example above may include data or attributes to complete this sample challenge phrase: “First Competitor” will “score more points” than the “Second Competitor” during “the second period of play in each respective Competitors+first game of the tournament.”

The picks engine 1340, according to particular embodiments, is configured to present options on a display and enable selections for users to pick. In another aspect, the picks engine 340 may also include rules, logic, limits, and standard data representations for the selections made by users. For example, the picks engine 340 for a particular game may display options to users according to rules and related conditions (whether this user has selected a time period or not, for example), and may limit user selections (not allowing picks to be changed once submitted, for example). The picks engine 1340 includes the data representation and specific processes for each challenge, as defined by the matchup logic 1310.

The event data handler 1360, according to particular embodiments, is configured to manage incoming data from each of the external data services 1280. Each external data service 1280 may have its own arrangement of data, which is different from other external data services. The event data handler 1360 includes a specific set of semantics for mapping the incoming data from each of the external data services 1280 to corresponding data locations according to the matchup logic 1310. In this aspect, event data handler 1360 parses, sorts, names, maps, and otherwise coordinates the incoming matchup data that is processed according to the matchup logic 1310.

The event data handler 1360, for example, may include semantics for mapping the incoming data about parameters such as the “starting roster” for real-world events like sporting events or competitions. Because the two competitors in a direct challenge may be playing in different games, on different days, the event data handler 1360 may be configured to receive and analyze data such as the “starting roster” in order to facilitate the building of a direct challenge.

The event data handler 1360, for example, may include semantics for mapping the incoming data about parameters such as the “start time” for real-world events like sports games. Because the two competitors in a direct challenge may not be competing against one another in a real-world game, and because their respective games may take place at different times, the event data handler 1360 handles start times and other parameters in order to facilitate the accurate gathering—and scoring—of data about each respective competitor in a direct challenge.

The matchup data, according to particular embodiments, may have the following attributes for describing and processing a direct challenge. For example, each Challenge may have these attributes: Event Date, Status (pending, in progress, completed, processed), and Source (the data feed or content service used to build the challenge and, later, to score the challenge). Each Challenge may include a Question with these attributes: Title, Mapping Pattern (the rules for calculating the score, such as the performance parameter and the time period), Correct Answer (including a reference to the Competitor who wins the challenge), and Score (the score defined for winning the challenge).

The Mano e Mano challenge application, according to particular embodiments, may be configured to allow users to build direct challenges by selecting competitors from a list, a database, or an external source of content. Information about upcoming competitions and games may be obtained from a variety of external data sources 1280 and presented to users as options in a drop-down list or other user-friendly interface. The challenge application may use a manual data interface, to allow challenges to be built by users without reference to external data.

In another aspect, the challenge application may be configured to automatically select and create a number of direct challenges between and among various competitors, and to then suggest such challenges to users for use in a direct challenge to a fellow user.

In particular embodiments, each external data source may have its own corresponding external data reader, which in turn uses its own corresponding event data handler. In this aspect, the system may include multiple external data readers 1380, and the event data handler 1360 may include multiple data handlers that work together to collect and organize data.

### Building a Direct Challenge

The following description and figures describe one example of the process of building a direct challenge. A direct challenge may be constructed in the following general format: “[First Competitor] will [outperform according to this performance parameter] the [Second Competitor] during [this event or time period].” In the following example, a first user (the Kehoesabe team) sends a direct challenge to a second user (the Dragon Army team), asserting that a First Competitor (Knowshon Moreno) will achieve more total yards than a Second Competitor (Matt Forte), during an entire day, placing a non-currency wager in the amount of 500 fantasy dollars, and paying a fee of 99 cents to cover both players.

In an alternative embodiment, the first user may send a direct challenge to all his friends, to all users in a particular group or category, or to all users system-wide. In this aspect, the direct challenge may be constructed and issued to a select group of users as an invitation to compete.

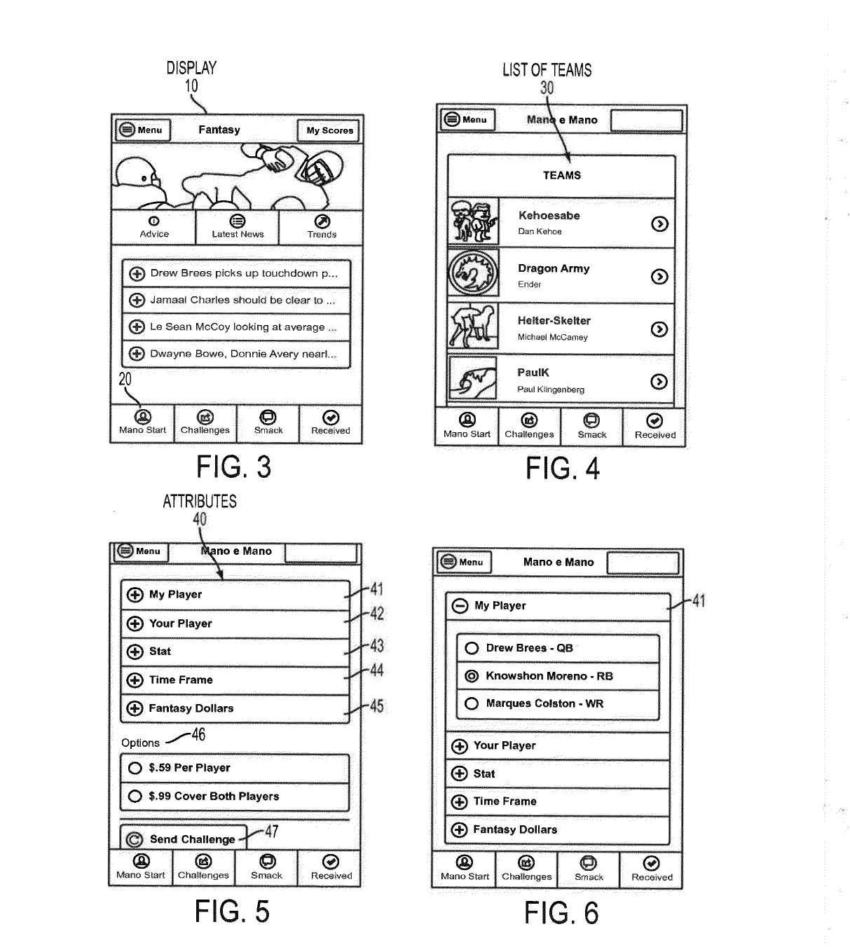

FIG. 3 illustrates a display 10 and includes a start button 20 (labeled Mano Start) for initiating the process of building a direct challenge. Next, when the button 20 is selected, the challenge application, according to particular embodiments, may open a display showing a list of teams 30, as shown in FIG. 4. In this example, each team represents a Fantasy Sports Team, which is a collection of players selected by a particular user. In this aspect, the list of teams 30, in effect, represents a list of users.

In this example, the first user is the user who owns the Kehoesabe team. The first user may select an opponent—here, he selects the Dragon Army team—after which, according to particular embodiments, the challenge application opens a display listing the attributes 40 of the challenge, as illustrated in FIG. 5. The attributes 40 include selectable icons for My Player 41 (or the First Competitor), Your Player 42 (the Second Competitor), Stat 43 (the performance parameter), Time Frame 44 (the time period), Fantasy Dollars 45 (an optional, non-currency wager on the outcome), Options 46 (for making payment to the provider of the direct challenge feature or other participating entity), and Send Challenge 47 (for sending the direct challenge once all the attributes have been selected).

As shown in FIG. 6, in response to selecting My Player 41, according to particular embodiments, the challenge application opens a display of competitors (on the first user's own team) who may be selected as the First Competitor for the direct challenge. In this example, the first user selects a player named Knowshon Moreno.

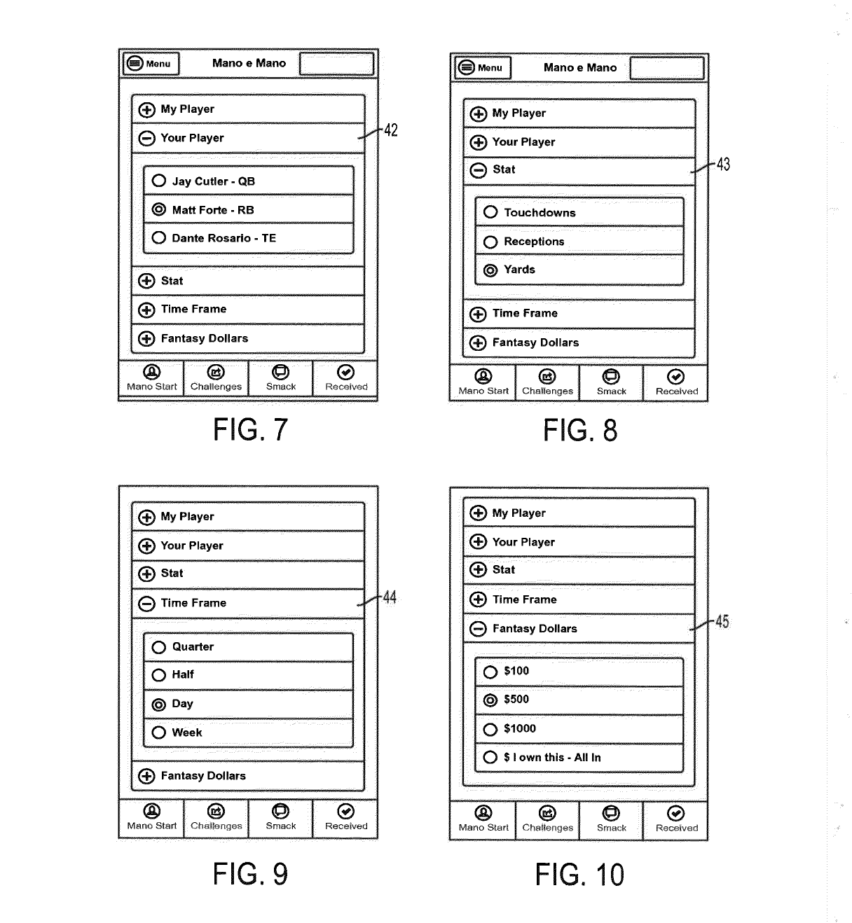

As shown in FIG. 7, in response to selecting Your Player 41, according to particular embodiments, the challenge application opens a display of competitors (on the opposing second user' s team) who may be selected as the Second Competitor for the direct challenge. In this example, the first user selects a player named Matt Forte.

As shown in FIG. 8, in response to selecting Stat 43, according to particular embodiments, the challenge application opens a display of statistics or other performance metrics that are available for this particular competition. In this example, the available metrics include Touchdowns, Receptions, and Yards. In this example, the first user selects Yards. For a basketball competition, for example, the available metrics may include Rebounds, Free Throws, and Three-Point Goals.

As shown in FIG. 9, in response to selecting Time Frame 44, according to particular embodiments, the challenge application opens a display of time periods, durations, or other temporally limited parameters that are available for this particular competition. In this example, the available time frames include Quarter, Half, Day, and Week. In this example, the first user selects Day.

As shown in FIG. 10, in response to selecting Fantasy Dollars 45, according to particular embodiments, the challenge application opens a display of non-currency wager amounts. In this example, the available wagers include $100, $500, $1000, and $ I Own This All In. In this example, the first user selects $500.

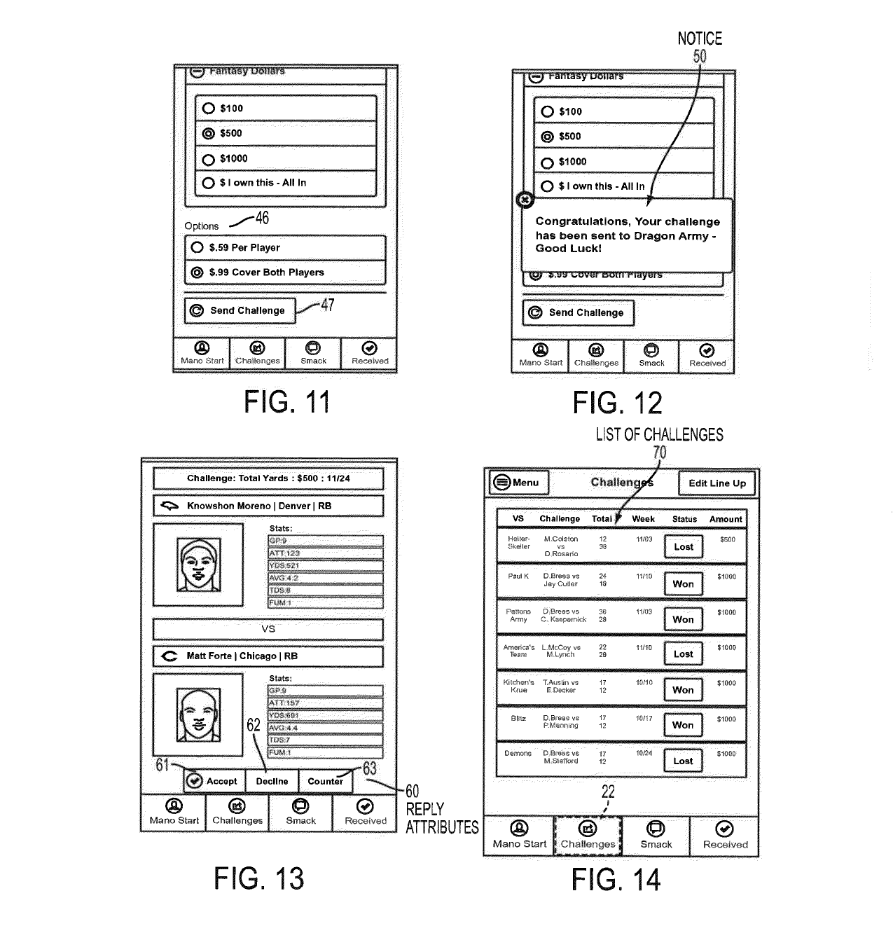

As shown in FIG. 11, in response to selecting Options 46, according to particular embodiments, the challenge application opens a display of payment options. In this example, the available payment options include $0.59 per Player or $0.99 Cover Both Players. In this example, the first user selects $0.99 Cover Both Players.

As shown in FIG. 12, in response to selecting Send Challenge 47, according to particular embodiments, the challenge application displays a notice 50 confirming that the direct challenge has been sent to the second user (owner of the Dragon Army team). If no second user has been selected, the challenge may be published or displayed to a selected subset of users or to all users, as an invitation to compete.

FIG. 13 illustrates the presentation of a direct challenge to the second user, according to particular embodiments of the challenge application. As shown, the challenge application may display the two Competitors (along with related information), the challenge metric (“Total Yards”), the time period (date), and the fantasy wager. The display may also include a message about which user paid the fee.

As shown in FIG. 13, the challenge application, according to particular embodiments, includes a display of reply attributes 60 for use by the second user upon receiving the direct challenge. The reply attributes 60 includes selectable icons for Accept 61, Decline 62, and Counter 63. In response to selecting Accept 61, the challenge application sends a notice to the first user that the challenge has been accepted without changes. In response to selecting Decline 62, the challenge application sends a notice to the first user that the challenge has been declined. In response to selecting Counter 63, the challenge application provides a series of displays to the second user, along with selectable icons for making changes to the attributes of the direct challenge. When completed, the challenge application provides the second user with a “Send Challenge” icon in order to send the amended challenge (the Counter) back to the first user for consideration.

FIG. 13 illustrates a list of challenges 70 on a display. In response to selecting the icon labeled Challenges 22, the challenge application displays a list of challenges 70 along with one or more filters or categories. In this example, the list 70 includes the name of the opposing user (the second user), the title of the challenge, the score, the date, the status (won or lost), and the wager amount if any.

### Two-Versus-Two Direct Challenges and More

The challenge application, according to particular embodiments, may be configured to allow users to build a two-versus-two challenge; that is, a contest between two first competitors and two second competitors. In this aspect, the First Competitor may be a group of two or more, and the Second Competitor may be a group of two or more, where both groups have the same number of participants. In this embodiment, each pair of opposing competitors may have its own performance parameter (rushing yards or total yards, for example), each pair may have its own wager and/or fees, and the time period may be long enough to include several real-world games. In this aspect, the challenge application may be configured to facilitate the building of challenges with three or more competitors—or an entire team—on each opposing side.

### Social Reporting Engine for Challenges

In another aspect, the challenge system 1100, according to particular embodiments, is designed to facilitate the creation and play of a plurality of direct challenges and to actively collect user data across an entire superset of challenges between users using a module referred to as the Social Reporting Engine 1500, as shown in FIG. 2. The Social Reporting Engine 1500, according to particular embodiments, gathers user data—including user behavior during registration and use of the game system, during game play, during interactions, during social-media actions, and during challenges—across multiple games, over an extended period of time, resulting in the population and updating of potentially millions of user data profiles, which may be stored in a user database 1520.

User data includes initial profile data provided voluntarily by the user. The challenge system and/or game system provider may also gather user data by query or otherwise at any time. User data also includes game performance by specific game played; including, for example, whether the user makes accurate predictions in a particular sport, and whether the user consistently likes or prefers a certain product, service, or company. In a preferred embodiment, user data will be aggregated in order to derive business intelligence and other useful information in a manner that does not sell or disclose personally-identifiable information. The user data may be provided in an aggregated or anonymized format; however, such user data is valuable because the user data collected and stored by the game system of the present invention includes a variety of useful demographic information, combined with a history of user behavior within the game system and related activities, as described herein. This combination of demographic information and actual user behavior contributes to the value of the user data collected and stored by the game system.

### Crowd Wisdom from Challenges

In another aspect, the social reporting engine 1500, according to particular embodiments, includes a crowd wisdom module for analyzing and ranking a number of head-to-head challenges, by subject, over a predetermined time period, in order to identify the crowd wisdom about a particular subject. In use, the module may identify a subset of challenges that are most often correct about a particular subject, and build a report about that subset for a customer.

In this aspect, the crowd wisdom module is tasked with exploring a particular subject (sports, movie awards, and the like), identifying the challenges that are most often correct about the subject, and analyzing those predictions over a period of time for consistency and accuracy. Because the challenge system 1100 includes a large number of players, participating in multiple head-to-head challenges, over an extended period of time, the challenges that are most often correct represent the crowd wisdom of all the players who use the challenge system. In the commercial context, the crowd wisdom has value because it represents actionable business intelligence that is useful in a variety of contexts.

### Crowd Guru for Challenges

In a related aspect, the social reporting engine 1500, according to particular embodiments, includes a crowd guru module for analyzing and ranking a number of head-to-head challenges, by user and by subject, over a predetermined time period, in order to identify an expert subset of users (i.e., the crowd gurus) who most often win challenges about a particular subject. In use, the crowd guru module may identify the users who are most often winning challenges about a subject, and may report the identity or those gurus to a customer.

In this aspect, the crowd guru module finds those users who most often win challenges about a particular subject (sports, movie awards, and the like) and identifies each such user as a Crowd Guru. According to particular embodiments, each user's challenges are analyzed over time, by subject, to determine the user(s) who win challenges most often. Because the game system includes a large number of players, participating in multiple head-to-head challenges, over an extended period of time, the users who win challenges most often may be identified as Crowd Gurus about that particular subject. In the commercial context, the game challenges made by a Crowd Guru, or a subset of Crowd Gurus, has value because it represents actionable business intelligence that is useful in a variety of contexts. The crowd guru module will score users on the number of challenge wins, in specific verticals, and aggregate the challenges made by the top experts (the Crowd Guru performers who are members of a rolling list, based on most-recent results), analyze the data using the Social Reporting Engine 1500 and other tools, and use that data to generate Crowd Guru data for commercial sale, presented for example in the business intelligence reporting console, described herein.

The crowd guru module, according to particular embodiments, is configured to identify the best-performing users in each game category, by aggregating challenge scores and wins over time, by category or by other selected metric, and maintain a rolling subset of top performers. For example, the Top 5% Winners of Monday Night Football Challenges, the Top 10% Winners of Challenges During March Madness, and the like.

In this aspect, the challenge system 1100 and social reporting engine 1500 may be used to identify: (a) the Crowd Wisdom related to a particular topic, and/or (b) the Crowd Guru performers, based on their actual win/loss performance across a subset of head-to-head challenges about the topic. Unlike existing tools sometimes referred to as prediction engines, the crowd wisdom module and crowd guru module will be based on actual performance in head-to-head challenges.

### Fantasy Games

Currently available fantasy sports systems prohibit in-game player substitutions, which is limiting user enjoyment and preventing users from behaving more like the coaches and owners of real sports teams. The limits are currently in place, at least in part, because designing and administering a more highly interactive system of player substitutions presents a variety of technical and logistical challenges. Nevertheless, many fantasy users strongly desire more interaction and flexibility, particularly during fantasy matchups when their players are participating in real-world sporting events.

Rookie players represent one of the biggest risks in fantasy sports. Many rookies either do not play well or spend much of their first season on the bench. Currently available fantasy sports systems require users to treat rookies just like any other player. Many users, however, strongly desire a fantasy system that handles rookies in a different and more realistic way.

Fantasy sports is a competition in which each user selects and manages an imaginary or fantasy team comprised of real players of a particular sport. Each user accumulates points according to the real-world performance of each player. Typically, the user assumes the role of team manager or coach, choosing players in a draft process, trading players, establishing active rosters and inactive (bench) rosters, changing rosters, and the like, in accordance with each particular league's set of rules and regulations.

Although many of the systems and methods described herein are discussed in the context of fantasy football, the technology disclosed herein is also useful and applicable for a variety of sports and in other contexts.

### In-Game Roster Moves

Currently available fantasy sports systems include a Team Roster (selected by the user during a formal draft process). Before an upcoming game or subset of games, the user selects from the Team Roster a set of players for an Active Roster before a deadline. The remaining, unselected players remain on the user's Bench Roster. During the upcoming subset of games, the fantasy sports system may follow and evaluate the performance of the players on the Active Roster, during each live game in which each player participates, signing points related to player accomplishments.

### Active Reserves

The roster management systems and methods described herein include Active Reserves. According to particular embodiments, the Active Reserves list describes a list of players, selected from the user's Team Roster, who are available for substitution during a live, real-world sporting event or game.

In one embodiment, the Active Reserves may include a subset of one or more players selected by the user from the Bench Roster before the beginning of the subset of games. Alternatively, the Active Reserves list may include all the players on the Bench Roster, requiring no advance selection by the user. Providing the Active Reserves list allows the user to behave more like the coach or manager would act during a real game.

In operation, the roster management system may include an in-game substitution module that is configured to permit the user to replace an active player with a substitute player selected from the Active Reserves while a fantasy matchup is in progress. Because the active players from the Active Roster may be participating in different live games at different times, the in-game substitution module may be configured to first identify and select a fantasy matchup that is currently in progress—in other words, a fantasy matchup in which one of the user's players on the Active Roster is currently playing in a live game. In a fantasy league for the NFL, for example, the subset of games may include football games played during a particular weekend; between a Thursday and the following Monday night. The active players from the fantasy Active Roster may be participating in different football games at different times during this period. The in-game substitution module may be configured to monitor and control the timing of substitutions to coincide with each active player's participation in a live game. In various embodiments, the module may receive one or more active feeds of information, referred to herein as feed data 25 and described below.

A system architecture includes a Service Interface 400 that would allow fantasy league operators to easily integrate the roster management system (including in-game substitutions) into their existing fantasy sports applications, such as those provided by Yahoo!, CBS, ESPN, NFL, and others. The roster management system, using the Service Interface 400, may also be operated as part of a separate or stand-alone fantasy sports system.

The Service Interface 400 may be an API (application programming interface) which, in general, specifies and controls the operation between and among various software components. In addition to accessing databases and computer hardware, an API can be used to control how the overall system executes routines, builds and accesses data structures, performs services, and makes “API calls” to other elements (for example, to provide data or seek data).

The Service Interface (API) 400, as shown, may include a variety of components connected to a database 500 and feed data 25. The database 500 may include a single database, a set of lookup tables, a set of relational databases, or any other structure for storing and accessing information. The feed data 25 may include a number of incoming data feeds containing a variety of information about all aspects of a sport. For example, the feed data 25 may include a list of the games currently in progress, a list of the players who are actively participating in each game, player status (active, benched, injured, removed, ejected, etc.), game scores, team field position, player injury reports, weather, penalties, along with any of a variety of statistics and performance information.

The Service Interface (API) 400 may be part of one or more central Server machines, which interact with remote Client devices, such as desktop computers, laptops, tablets, and handheld devices.

The roster manager 410 may be configured to process roster data and to receive and handle requests from users (Clients). The roster manager 410 may access other components, including for example the feed stats data handler 470, in order to access and evaluate real-time statistics. The roster manager 410 may be configured to process requests for substitution (described below) and execute player substitutions according to the rules and conditions imposed by particular embodiments of the roster management system.

The notification engine 420 may be configured to analyze team roster data and real-world events from the feed data 25 and, based on that analysis, configure and send one or more notifications to users. The notifications may include information about that user's team members, such as a player's performance or current statistics. Also, as described below in greater detail, the notifications may include one or more prompts to a user, reporting current information about a relevant player or game and suggesting a substitution.

The user manager 430 may be configured to set and maintain the API settings so that each fantasy sports provide can manage its own set of rules.

The fantasy score handler 440 may be configured to perform the scoring function, based on data received about each athlete's plays and performance and, optionally, to award fantasy points.

The reporting engine 450 provides a flexible reporting interface for users to view how their coaching decisions (i.e., player substitutions) affected the outcome of their fantasy matchups. The reporting interface may allow the user to filter the views by type of substitution, by position, by time period, relative to certain opponents, etc.

The roster data handler 460 may be configured to house the logic for particular elements of the roster management system, including the storing of roster data and substitution processes on the database 500.

The feed stats data handler 470 may be integrated with one or more incoming sports feed services which are part of the feed data 25. The handler 470 may retrieve and parse particular statistics from the feed data 25, store the relevant data in the database 500. The handler 470 may also be configured to manage the relatively high frequency and number of data requests, as well as to maintain an accurate historical log of events that take place using the roster management system.

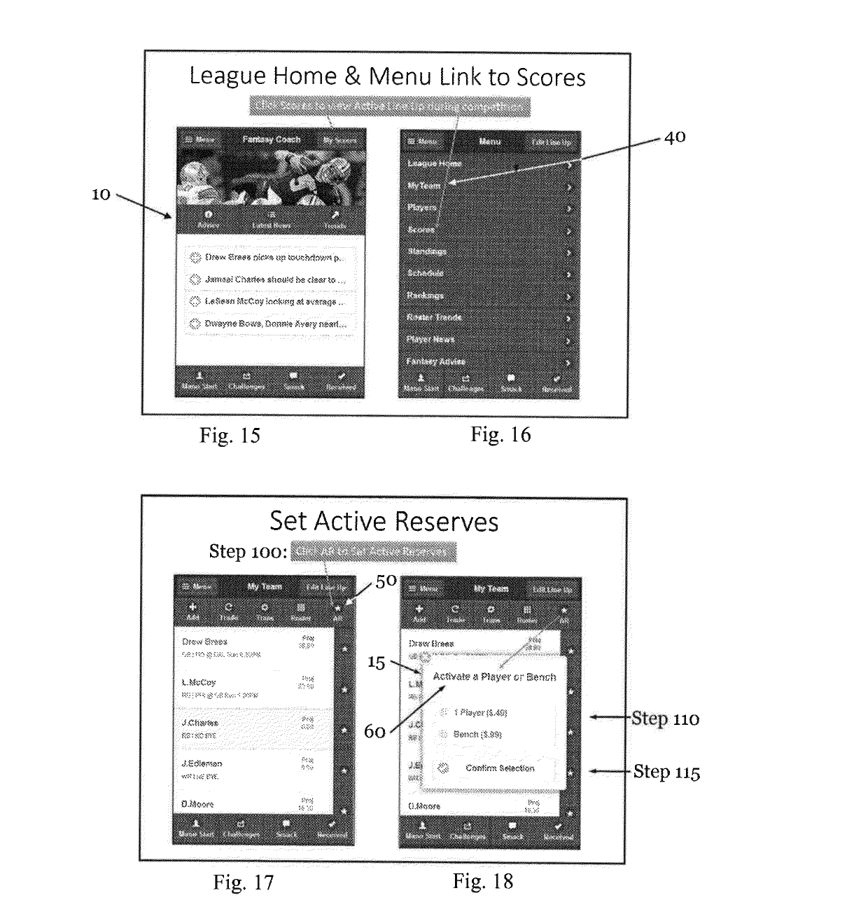

FIG. 15 is a screen shot of a graphical user interface and display, on an interactive device, with which a user may receive information, identify and select players, and execute substitutions. The display 10 may include any of a variety of usefully information from various sources about one or more fantasy sports activities, such as a list of scores, a news feed about games and players, and a plurality of menus and sub-menus for accessing and executing various elements of the roster management system described herein.

FIG. 16 illustrates a menu of options including My Team 40. The display for My Team 40, shown in FIG. 17, may include, for example, a list of the Active Roster selected by the user for an upcoming subset of games. As shown in this example, the Active Roster may include Drew Brees as quarterback, McCoy and Charles as running backs, etc. The display in FIG. 3 may also include an Active Reserves icon 50 (illustrated using a star and the letters “AR” in this example). The icon 50, when selected, allows the user to access the Active Reserves feature as described herein.

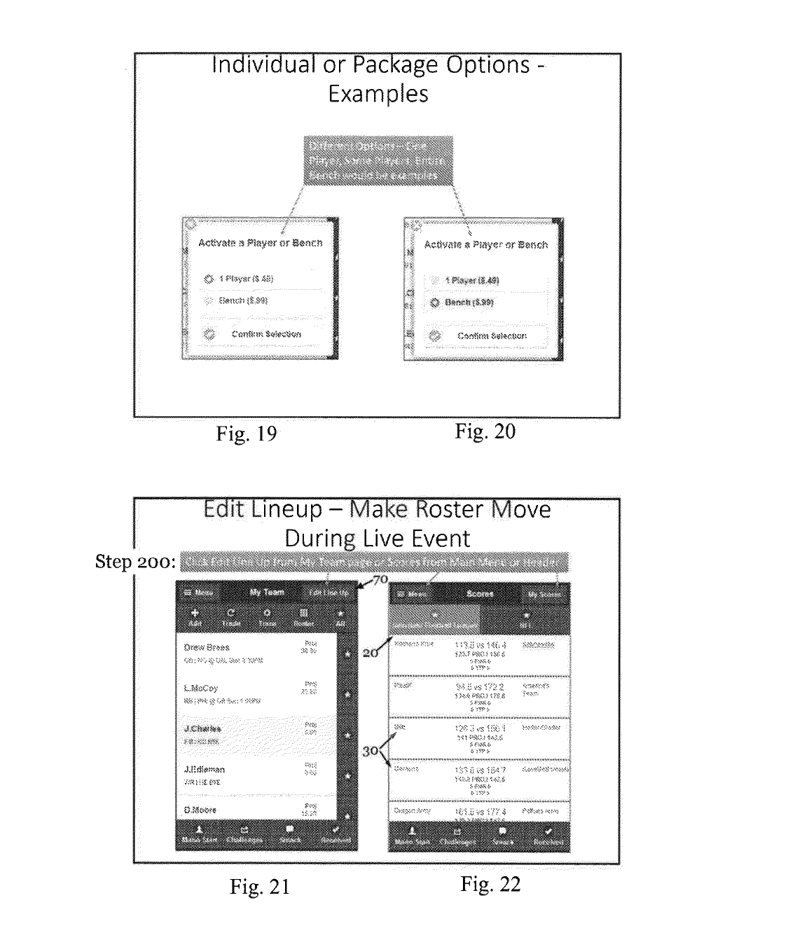

The process of selecting players for an Active Reserves list, according to particular embodiments, may include a Step 100 of selecting the AR icon 50, by a finger touch or mouse click, for example. FIG. 18 illustrates a smaller window 60 inviting the user to select and activate (Step 110) a single player or the entire Bench Roster and then confirm the selection (Step 115). FIGS. 19 and 20 illustrate the options presented in this embodiment.

The substitution module, according to particular embodiments, is illustrated in the figures, beginning at FIG. 21. As shown, the display for My Team 40 in may include a button or icon that, when selected, allows the user to access the in-game substitution feature of the system described herein. In the example shown in FIG. 21, the button 70 is labeled “Edit Line Up” and it may be selected by using a finger touch, mouse click, or other pointing and selecting device.

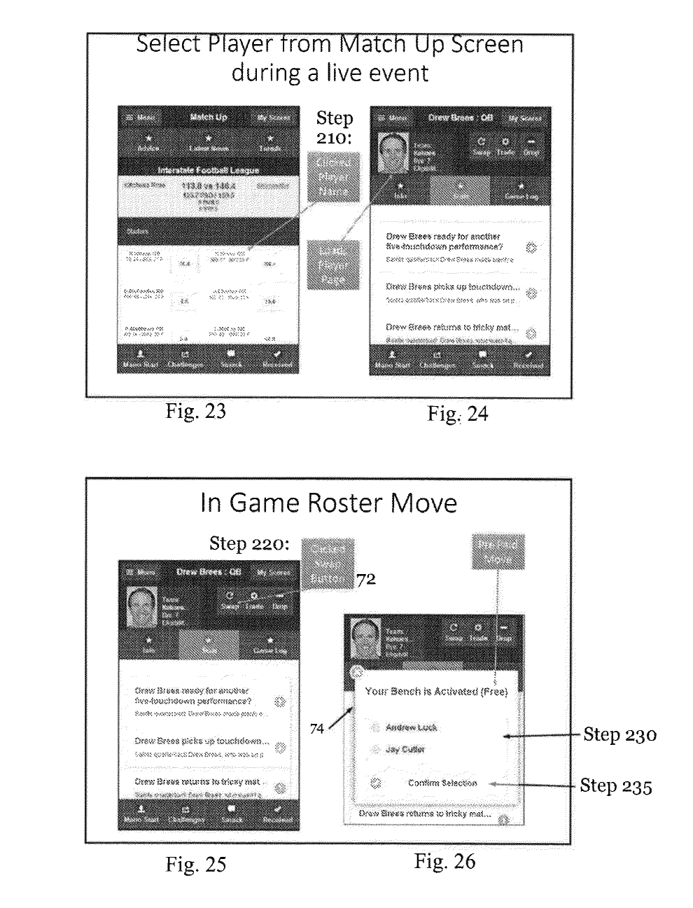

As illustrated in FIG. 22, the next screen display on an interactive device may include a display of Fantasy League Names 20 and/or a list of the Team Names 30 selected by individual users. Selecting one of the League Names 20, according to particular embodiments, may cause the system to display the status of one or more active contests with others, including a list of the user's Active Roster, as shown in FIG. 23. As shown in the display, the League Name is “Interstate Football League” and the contest is between the users called “Kitchens Krue” and “Kehoesabe.” In this example, the user called Kehoesabe may be referred to as the primary user because his user has the authority to access and operate the interactive device illustrated in the figures. The primary user's team name (Kehoesabe) is highlighted. The Active Roster or “Starters” for Kitchens Krue are listed in left column; the Active Roster for Kehoesabe are listed in the right column. According to particular embodiments, the players on the primary user's Active Roster who are currently participating in a live game may be highlighted. As shown in FIG. 23, the highlighted players include “D. Brees QB” and “J. Charles RB” in the right column. As shown, the display may include statistical or performance information about the players. Because the highlighted players are currently participating in a live game, the in-game substitution feature may be configured to allow the user to make a substitution; i.e., to replace a selected active player with a player selected from the Active Reserves.

Selecting one of the highlighted players in FIG. 23 (Step 210), according to particular embodiments, may cause the system to display a variety of information about the selected player (as shown in FIG. 24). The display may include general information, statistics, news, comments by others, information about a game in progress, and any of a variety of other types of information about the selected player. In this example, FIG. 24 displays information about Drew Brees.

The display, as shown in FIG. 25, may include a series of icons or buttons, including a swap icon 72 (illustrated using a circular symbol with arrowhead and the word “Swap” in this example). Clicking or otherwise selecting the swap icon 72 (Step 220) indicates that the primary user wishes to select this player for removal from the live game.

As illustrated in FIG. 26, the in-game substitution module may then display a selection window 74 which, according to particular embodiments, includes a list of the players from the Active Reserves list who are both capable of and available to replace the selected player. A capable substitute is one who plays the same position or role in the sport. For example, only a running back may be a capable substitute for replacing a running back. As shown in FIG. 26, the selected player to be replaced is Drew Brees (a quarterback), so the in-game substitution module is configured to display in the selection window 74 a list of quarterbacks who are available on the user's Active Reserves list (here, quarterbacks Andrew Luck and Jay Cutler are available). Player availability, according to particular embodiments, is determined according to a predetermined set of conditions, discussed in more detail below.

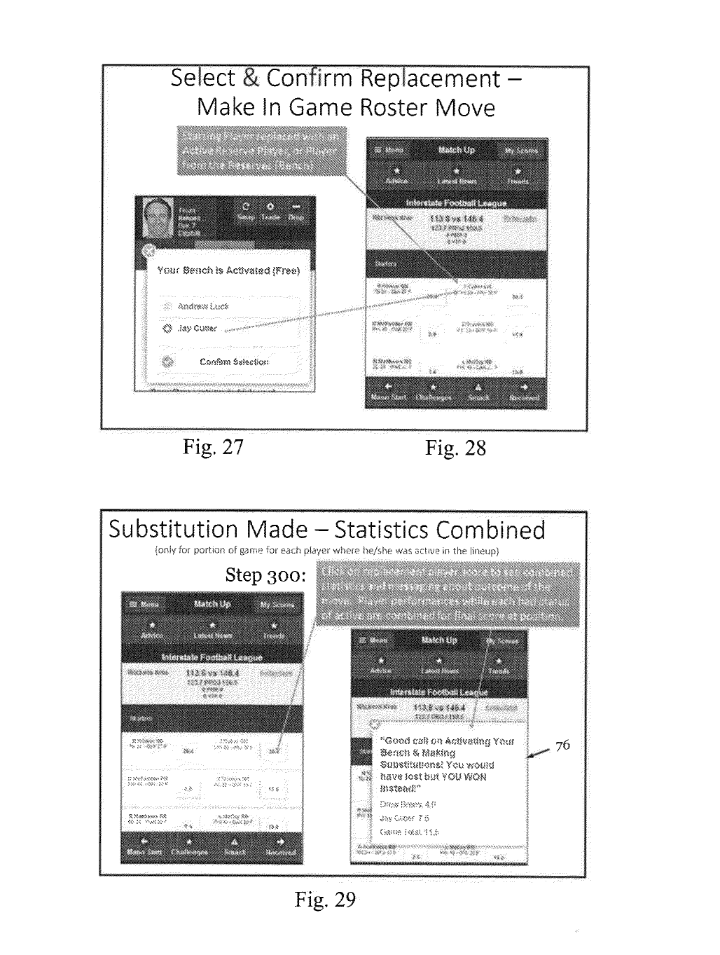

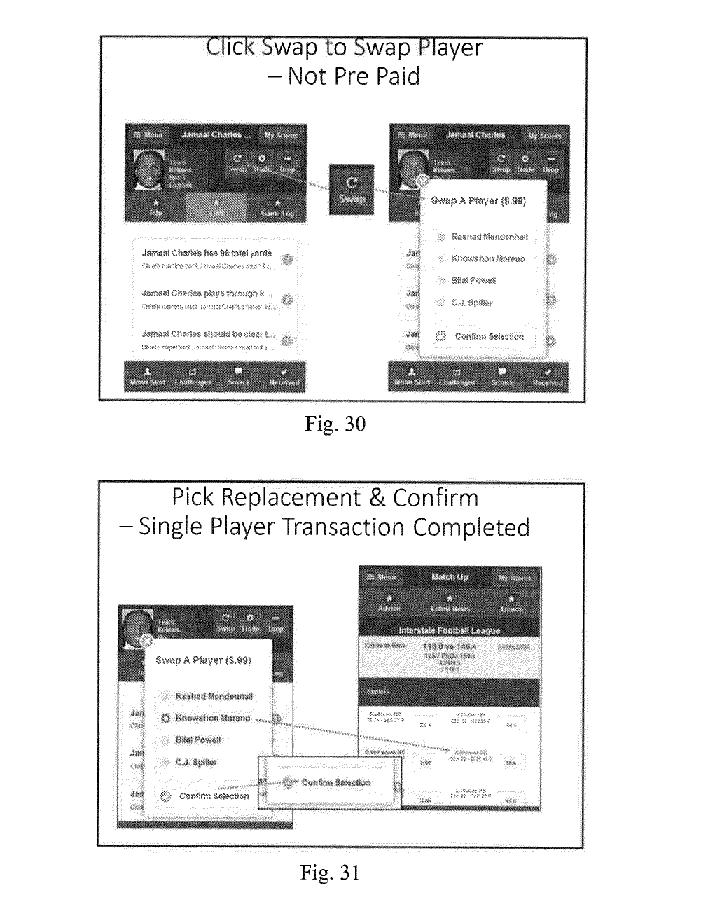

As shown in FIG. 27, the user may select and activate one of the players (Step 230) and then confirm the selection (Step 235). In this example, the primary user selects Jay Cutler. After the substitution is made, the system may then display the primary user's updated Active Roster or “Starters” as shown in FIG. 28 (where “J. Cutler QB” now appears in the right column). A similar example illustrating the selection and replacement of a running back is illustrated in FIGS. 29 and 30.

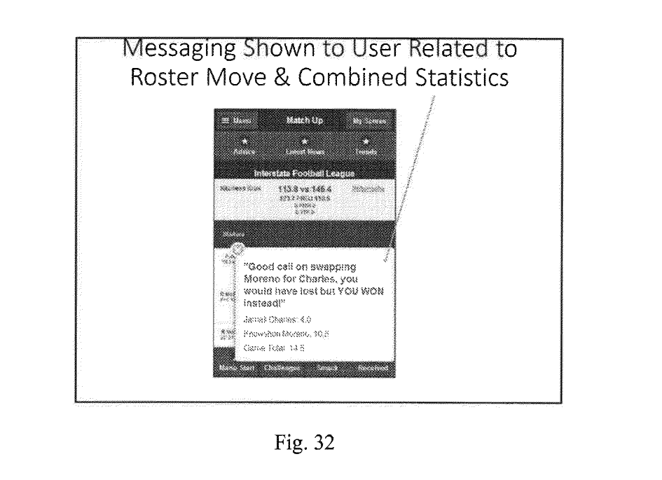

Reporting is another aspect of the in-game substitution module, according to particular embodiments. As illustrated in FIG. 31, the user may click on the score achieved by a substitute player (Step 300)—J. Cutler QB in this example—in order to view a message window 76 displaying data about the substitution event. As shown, the message window 76 may include scores achieved or other data about the players involved in a substitution, along with a message about the consequences of the substitution (for example, whether the substitution was a good call or not). The message window 76 may also include a variety of other information, including statistics, real points scored, fantasy points scored, time stamps related to the substitution, and other information. A similar example illustrating the reporting of results for substitution of a running back is illustrated in FIG. 32.

### Availability Conditions

The roster management system, according to particular embodiments, determines whether certain players are available for in-game substitution according to a set of predetermined conditions.

Most sporting events progress according to a number of time periods, with a possible period of overtime play. A substitution takes place when an active player is replaced by a substitute player, subject to a set of availability conditions.

The active player, to be eligible, must be (1) currently on the user's Active Roster, and (2) currently playing in a real-world game that has not yet entered the final period of play. In other words, the active player must be currently ‘playing’ in a fantasy matchup (a game between two fantasy teams). In the example described above, quarterback Drew Brees was highlighted in the display 10 as an available active player because he was on the user's Active Roster and currently playing in a football game that had not yet entered the final period.

The substitute player, to be eligible, must (1) play the same position as the active player, (2) be placed on the Active Reserves list prior to the deadline, and (3) currently playing in a real-world game that has not yet entered the final period of play or scheduled to play in a real-world game that has not yet started. In the example described above, two quarterback—Andrew Luck and Jay Cutler—were displayed in the substitute player selection window 74 because each player (1) played quarterback, (2) was on the user's Active Reserves list, and (3) was either currently playing in a football game that had not yet entered the final period or was scheduled to play in an upcoming football game that had not yet started.

The final-period condition may be imposed in order to comply with the limited substitution opportunities, as described in more detail below, which may require that substitutions take place only at the end of a play period. In this aspect; if the active player is currently playing in a game that he already entered the final play period, then there would be no more substitution opportunities.

The final period, as used herein, may be an extra play period following the regular or regulation play periods, such as overtime in football and other sports, extra innings in baseball, a penalty shootout in hockey, and a period of ‘injury time’ or ‘stoppage time’ in soccer. If a substitution is requested during the final period of regular play, then the system may be configured to allow the substitution to occur during the next opportunity; i.e., after the end of regular play and the beginning of overtime play. If a substitution is requested and there is no overtime, then the system may issue a credit to the user for that request.

### Duration

The Active Reserves list may be used during any of a variety of time periods. In a fantasy season, for example, the relevant time periods include: (a) the entire season, over a number of weeks, including a playoff period, (b) the entire set of regular games in a season, not including playoff games, (c) a subset of games within the season (for example, all the games played on one day, during one weekend, during a single week or group of weeks), and (d) a subset of time during a single game (one period; for example, a quarter in a football game, or a half-inning in baseball game). The roster management system may be configured to manage and coordinate the duration or time period during which the Active Reserves features is available to a user.

FEES is another aspect of the roster management system. For example, the Active Reserves and in-game substitution feature may be provided by a particular league operator or other managers for no fee, for a single fee per time period, or some other usage-related fee. The league operator, for example, may charge a single fee, per time period (e.g., entire season, subset of games, single game, single period) for unlimited use of the Active Reserves and in-game substitution feature. The league operator, for example, may charge a first fee for a predetermined number of substitutions X and then charge a second fee for each subsequent substitution Y. The league operator may also elect to charge higher fees for elite players, or critical positions, for example. In this aspect, the roster management system as described herein may be configured to permit the league operator to establish any of a variety of fee systems for use of the features and functions described herein.

NUMBER OF ALLOWED SUBSTITUTION EVENTS is another aspect of the roster management system which may be configured and customized according to the league operator or other managers. For example, the system may be configured to allow an unlimited number of substitution events. For an Active Reserves list that includes 8 players, for example, the user may execute up to 8 substitutions at each opportunity that is available during a live game. When an Active Player is replaced, he becomes part of the Active Reserves and is thus available for substitution at the next opportunity. Similarly, if an Active Reserves player is activated and then later benched, that player is again available for substitution at the next opportunity. In this aspect, the selection of 8 players for the Active Reserves list creates a set of 8 substitution events, at each substitution opportunity, involving any Active Player and/or any Active Reserves player.

In a different example, the roster management system may be configured to allow a limited number of substitution events. For an Active Reserves list that includes 8 players, for example, the user may be limited to a total of 8 substitution events during any single live game, and no more. The system may also limit the repeated use of players; for example, if an Active Player is replaced, the system may place him on the Bench Roster instead of the Active Reserves list, thus making him not available for substitution. Similarly, if an Active Reserves player is activated and then later replaced, that player is placed on the Bench Roster and is no longer available for substitution.

SUBSTITUTION OPPORTUNITIES. The number of substitution opportunities may be limited to a predetermined list, according to particular embodiments of the roster management system. In other words, the roster management system may be configured to allow a substitution event to take place only during one or more predetermined times. For example, the system may allow substitution events to occur at the end of a period of play (except for the final period, of course, because the game has ended). The substitution opportunity time window would start at the end of a play period, and stop at the beginning of the next play period. The request to execute a substitution, as described below, may be made at any time, according to particular embodiments.

In NFL football, for example, the system may be configured to allow substitution events to occur at the end of each quarter. The substitution opportunity time window would start at the end of a quarter, and stop at the beginning of the subsequent quarter.

The final period, as used herein, may be an extra play period following the regular or regulation play periods, such as overtime in football and other sports. In the case of overtime, the time window would start at the end of the final regular play period, and stop at the beginning of the overtime play period.

In an alternative embodiment, the roster management system may be configured to allow real-time substitution events—replacing a player in a live game during an active play; for example, replacing the quarterback after the snap but before he throws a pass and/or replacing the wide receiver while the football is in the air. This embodiment would require a sophisticated level of computing power and a highly detailed real-time live data feed in order to accomplish this level of granularity and precision. In this embodiment, the fantasy user may use the system to accomplish events that are beyond what the rules allow for real coaches and managers. At the other end of the spectrum, the system may be configured to allow only one substitution event—at or during the occurrence of one predetermined time or event during a game (at halftime, for example).

The system may also be configured to provide numerous substitution opportunities during a game; for example, during any time-out, during any period when the official clock is stopped, after any change in possession, during any commercial break, or at any time period recognized by the roster management system as a finite or discrete time window. In this aspect, the roster management system relies, to some extent, on the availability of incoming data feeds (from the real-world sporting events) and the level of detail contained in each such data feed. In another embodiment, the system may be configured to allow substitution events to take place between two discrete events in a game. In NFL football, for example, the system may allow substitutions of defensive players to be made between the start of an offensive drive and the end of an offensive drive, and the like.

REQUESTS FOR SUBSTITUTION, according to particular embodiments, may be received and processed by the roster management system described herein at any time before a future substitution opportunity. In other words, the roster management system may be configured so that a user may submit a request at any time, directing the system to execute a specific substitution at a future substitution opportunity—which might be the next available opportunity (the end of the next play period, for example), or at some future opportunity (e.g., during halftime, or at the end of the final period of regulation play (in which case, the request would only be executed if there is an overtime period)).

For example, during the first few minutes of play in an NFL game, a user may submit a request for the system to execute a quarterback substitution at the next available opportunity, which may be at the end of the first quarter. The current quarterback would complete the first quarter of play, and the system would execute the substitution so that the replacement quarterback starts play when the second quarter starts. In this aspect, the roster management system provides an active coaching experience for the user during all periods of play, and executes the substitution(s) only during the predetermined substitution opportunity times.

The time window for submitting a request for substitution may be limited by the roster management system. For example, the system may be configured to require users to submit a request no later than one minute before the end of a play period. At this deadline, the system would stop receiving requests to make a substitution for the end of that period. ‘Late’ requests would be executed at a future opportunity; either at the next available opportunity or at a user-selected future opportunity.

### Notifications

The roster management system may be configured to monitor real-world events and send notifications to users As illustrated in Exhibit A, the Service Interface 400 may include a notification engine 420 that is configured to access a user's roster data, to receive, parse, and otherwise process incoming real-world information from the feed data 25, and to prepare and send a variety of notifications to users containing information of interest. The notifications may include information about the players on the user's Active Roster, Bench Roster, or Active Reserves list, (or about another user's players), such as the player's performance or current statistics.

The notification engine 420 may also be configured to process data and generate notifications to a user reporting current information about a relevant player or game, and suggesting a substitution. In this aspect, such notifications might act as a proactive suggestion, prepared by the roster management system, that would be intended to prompt a user to consider making a player substitution. The notification engine 420 may be configured to create such a notification based on any of a variety of real-world events including, for example, player injuries (user's players and opponent's players), game scores, player performance trends, weather, player penalties, players benched or ejected, player status (such as elapsed playing time, pitch count, shots taken, and the like.)

Using an NFL football game as an example, coaching decisions typically change if and when one team achieves a large point lead over the other team. The trailing team usually passes the ball more often, and rushes less often, creating a scenario in which passing receivers have more opportunities to score fantasy points, and in which running backs have fewer opportunities to score fantasy points. In this scenario, a fantasy user (like the trailing team's coach) may elect to make a substitution and, for example, make his strongest passing receiver an active player.

Large point differentials may also cause the coach of the leading team to bench one or more starting players. While benched, those players cannot score fantasy points, so the user may wish to make a substitution from his Active Reserves, to make sure that his fantasy team has the ability to score points.

Player injuries also affect coaching decisions, sometimes dramatically. While a player is injured, that player cannot score fantasy points, so the user may wish to make a substitution. Also, a player injury may generate a notification regarding opposing players. For example, if a key defensive player with primary responsibility for preventing wide receivers from catching passes is injured, then a less-talented defensive player will most likely play instead. This change might affect a fantasy user's decision to make a substitution of one or more wide receivers, who are now possibly more able to score points during the remainder of the game. In this aspect, receiving a notification about a single player or event can affect not only the user's decisions about that player, but also decisions about opposing players.

The notification engine 420 may also be configured to create a notification based on any of a variety of fantasy-related events, including but not limited to situations where a fantasy user may have a particular opportunity to score additional points. Suppose, for example, in a fantasy matchup, a fantasy user's opponent has played all his players and his games for the week are completed. The fantasy user may have one or more players who have not yet played. The notification engine 420 may calculate the points needed to win and send a notification to the fantasy user like this: “SanderZon's team has scored 136 points and his games are completed for the week. To win your matchup with SanderZon, you need at least 34 points from your remaining players, A and B (or from their replacements, if you make substitutions).” In this aspect, the system provides notifications so that participating fantasy users have the opportunity to make active coaching decisions, including substitutions, in conjunction with one or more real-world events, in order to improve their chances of winning a fantasy matchup.

Any of a variety of potential scenarios may develop in a real game that would prompt the notification engine 420 to generate and send a notification to select users. According to particular embodiments, the notification engine 420 may be configured to generate a notification in response to any event that would typically have an impact on the decisions made by an active coach in a real-world game, or in a fantasy matchup. In this aspect, the system provides notifications so that participating fantasy users have the opportunity to make active coaching decisions, including substitutions, in response to real-world events taking place during active games.

### Scoring

The roster management system may be configured to monitor and record the fantasy points scored by all the various players who are participating in a fantasy matchup. As illustrated in Exhibit A, the Service Interface 400 may include a fantasy score handler 440 that is configured to perform the scoring function according to a set of rules.

In the context of substitutions, in general, the active player would earn fantasy points for his performance during any period before a substitution is executed. The substitute player would then earn points based on his performance for the remaining play periods (or until the player is replaced by another substitution). For games occurring at different times, however, the fantasy score handler 440 may be configured to adjust the scoring according to a variety of factors, including the precise time when certain events occur.

The feature of allowing in-game substitutions in fantasy matchups—when the players are typically not playing at the same time, or in the same real-world game—creates a number of data processing challenges including player availability conditions (described above, including whether the real game has entered the final play period), substitution opportunities and time windows (between play periods, for example, as described above), and the scoring of fantasy points.

According to the timing requirements element of the availability conditions, described above, an active player is only eligible when currently playing in a real-world game that has not yet entered the final play period. A substitute player is only eligible when either (a) currently playing in a real-world game that has not yet entered the final play period or (b) scheduled to play in a real-world game that has not yet started. This set of conditions creates three possible scenarios.

The first scenario occurs when the substitute player is scheduled to play in a real-world game, called Game Two, that has not yet started. The user issues a request to substitute an active player in Game One. The fantasy score handler 440 records the request time, both in real universal time and relative to the Game One Clock. For example, a request is made when 2 minutes, 30 seconds has elapsed on the clock during period 2 in Game One. The Game One Clock in this example may be recorded as 2:02:30 (Period 2:02 minutes:30 seconds).

In a roster management system that executes substitutions only at the end of a period, the substitution of the active player would not take effect until the start of period 3 in Game One. The active player would continue scoring fantasy points until the end of period 2. For Game Two (which has not yet started), for scoring purposes, as controlled by the fantasy score handler 440, the substitute player would not ‘start’ playing and scoring fantasy points until the first new play of period 3 in Game Two.

In a roster management system that executes substitutions upon request, the substitution of the active player would take effect ‘immediately’ with the start of the next new play after the Game One Clock passes 2:02:30. For scoring purposes, as controlled by the fantasy score handler 440, the substitute player would not ‘start’ playing until the first new play after the Game Two Clock passes 2:02:30. In this aspect, the substitutions are time-coordinated according to the respective game clocks, even though Game Two has not yet started in real time when the substitute is requested and executed.

The second scenario occurs when the substitute player is currently playing in Game Two, (a) Game Two has not yet entered its final play period, and (b) Game Two started later than Game One and/or less time has elapsed on the Game Two Clock than the Game One Clock. The user issues a request to substitute an active player in Game One. The fantasy score handler 440 records the request time, both in real universal time and relative to the Game One Clock, which may be recorded as 2:02:30 (Period 2:02 minutes:30 seconds). In this scenario, the same scoring rules would apply as those in the first scenario.

In a roster management system that executes substitutions only at the end of a period, the substitution of the active player would not take effect until the start of period 3 in Game One. The active player would continue scoring fantasy points until the end of period 2. For GameTwo (which started later and is still underway), for scoring purposes, as controlled by the fantasy score handler 440, the substitute player would not ‘start’ playing and scoring fantasy points until the first new play of period 3 in Game Two. In a roster management system that executes substitutions upon request, the substitution of the active player would take effect ‘immediately’ with the start of the next new play after the Game One Clock passes 2:02:30. For scoring purposes, as controlled by the fantasy score handler 440, the substitute player would not ‘start’ playing until the first new play after the Game Two Clock passes 2:02:30. In this aspect, the substitutions are time-coordinated according to the respective game clocks, even though Game Two has not yet started in real time when the substitute is requested and executed.

The third scenario occurs when the substitute player is currently playing in Game Two, (a) Game Two has not yet entered its final play period, and (b) Game Two started earlier than Game One and/or more time has elapsed on the Game Two Clock than Game One Clock. In other words, Game Two started first and/or is further along and will presumably end sooner. In general, the fantasy score handler 440 may be configured to prevent a user from ‘going back in time’ and capturing points from the past performance of a substitute player.

The user issues a request to substitute an active player in Game One, at 2:02:30 according to the Game One Clock. Suppose, for example, that the substitution is executed when 4 minutes, 50 seconds has elapsed on the clock during period 3 in Game Two. The Game Two Clock may be recorded as 3:04:50 (Period 3:04 minutes:50 seconds).

In a roster management system that executes substitutions only at the end of a period, the substitution of the active player would not take effect until the start of period 4 in Game One. The active player would continue scoring fantasy points until the end of period 3. For GameTwo (which is in the middle of period 3), for scoring purposes, as controlled by the fantasy score handler 440, the substitute player would not ‘start’ playing and scoring fantasy points until the first new play of period 4 in Game Two.

In a roster management system that executes substitutions upon request, the substitution of the active player would not take effect immediately. The active player would continue scoring fantasy points until the end of any active play occurring when the Game One Clock reaches 3:04:50. The substitute player would not ‘start’ playing until the first new play after the Game Two Clock passes 3:04:50. In this aspect, the substitutions are time-coordinated according to the respective game clocks.

REPORTING is another aspect of the roster management system, as described herein. The Service Interface 400 may include a reporting engine 450 that includes a flexible and user-friend reporting interface. The reporting engine 450 may be configured to display a report to the user when a substitution is a success (results in more points or another favorable outcome) and/or when a substitution is a failure. The reporting engine 450 may monitor and report the results of a single substitution event or, alternatively, a set of substitution events that occur during a certain time period (the entire season, subset of season, one game, one day, one week or weekend, a particular subset of a game, etc., as described above). Comparisons with other users may be monitored and reported showing the results of the user's substitutions relative to those made by others during the same period (same game, same period, etc.).

Additionally, the reporting engine 450 may be configured to monitor and report the results of one or more substitution events made by a user relative to a certain person or subset, including for example, a report of the user's substitutions: (a) relative to a particular opposing user's substitutions, including optionally the net effect of his substitutions, (b) relative to a subset of the opposing users in a selected group or league, (c) relative to the substitutions of every user in a league as a group, and/or (d) relative to a subset of other users who meet a particular set of criteria, such as geographic location, school or workplace affiliation, team or fan group affiliation, users with the same player on their Active Reserves list, users who used the same player for a substitution during a particular time window, or any other set of criteria.

The reporting engine 450 may further be configured to maintain a record of past reports in a log or data store, such as the database 500. In this aspect, the roster management system may provide an historical record of a number of substitution events made by a user. The system may further include an analysis of the user's substitutions over time, in relation to other users, or relative to some other time period or metric. The system may provide a virtual ‘coaching history’ to the user, for example, showing the number of substitutions made during a certain week or during an entire season, displaying the percentage and number of substitutions that resulted in improved fantasy score, thereby providing an indication of the user's skill. The system may also include a comparison of the user's actual substitutions versus a set of other available substitutions that could have been requested, along with an indication of which substitution would have produced more fantasy points.

### Development Player Seat

Rookies represent one of the biggest risks in fantasy sports. Many rookies either do not play well or spend much of their first season on the bench, earning little or no fantasy points and taking up a seat on the roster. For the next season, the user must decide whether to select the rookie again in the draft, or instead select a different player.

Keeper-style fantasy sports leagues allow users to keep one or more players on their fantasy team from one season to the next. League rules determine the number of players who can be kept, as well as the cost or penalty to the user for making the election to keep a player on the team. For example, the rules may allow players to keep up to six (6) players for the next season.

In another aspect, the roster management system may include a designated seat on the Bench Roster for one Development Player. The Development Player seat may be particularly well-suited for a rookie player, in a keeper-style league, according to particular embodiments. In operation, the user would select a rookie in the draft and assign the rookie to the Development Player on the Bench Roster, where the rookie must remain for the entire first season. At the end of the first season, in a keeper-style league, the user would have the option to ‘keep’ the rookie and move the rookie to the Active Roster for the rookie's second season.

In one embodiment, the roster management system would provide the user with an option to use one (1) additional keeper slot in order to capture the Development Player (rookie) for his second season. For example, in a league where the rules allow users to keep up to six (6) players for the next season, the rules would allow the user to also keep the Development Player (the rookie) as a seventh keeper for the next season. In this aspect, the user accepts the rule that the Development Player remains on the Bench Roster during the entire first season, in exchange for the option to use the Development Player as ‘one additional keep’ at the end of the season.

Although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims or inventive concepts. Moreover, although specific terms are occasionally used herein, as well as in the claims or concepts that follow, such terms are used in a generic and descriptive sense only, and should not be construed as limiting the described invention or the claims or concepts that follow.

What is claimed is:

1. A system for managing a plurality of direct challenges between users of a game application, said system comprising:
an application services interface comprising a database and an external data reader in communication with a plurality of external data services;
a plurality of user interfaces to facilitate access to said application services interface; and
a challenge application comprising a non-transitory computer-readable medium containing program instructions for managing a plurality of direct challenges between users, and one or more processors of a computer system coupled to said non-transitory computer-readable medium executing said program instructions to:
receive a first competitor selected by said first user for participation in a first direct challenge;
receive a second competitor to serve as a rival of said first competitor in said first direct challenge;
receive a performance parameter for said first direct challenge;
receive a time period for said first direct challenge;
receive an acceptance from a second user and, in response, deploy said first direct challenge;
instruct said external data reader to collect a first set of actual performance data for said first competitor during said time period, and a second set of actual performance data for said second competitor during said time period, from at least one of said plurality of external data services;
calculate a score for said first direct challenge, wherein said score is based on a comparison of said first set of actual performance data and said second set of actual performance data;
report said score to said first user; and
store said score in said database.

2. The system of claim 1, wherein said one or more processors further execute said program instructions to:
present said first direct challenge to said second user on a display;
provide said second user with an option to submit a response consisting of an indicator selected from the group consisting of accept, decline, and counteroffer;
receive said response from said second user; and
in response to receiving said response equal to counteroffer, present one or more attributes of said first direct challenge to said second user for review and modification.

3. The system of claim 1, wherein said first competitor comprises a first team, and said second competitor comprises a second team.

4. The system of claim 1, wherein said first competitor comprises a first group of two or more, and wherein said second competitor comprises a second group of two or more, wherein said second group has the same number of participants as said first group.

5. The system of claim 1, wherein said one or more processors further execute said program instructions to:
receive a selection of a first non-currency wager related to said first direct challenge; and
apply said wager to said first direct challenge based on said score.

6. The system of claim 1, wherein said application services interface further comprises a challenge reporting tool for displaying a plurality of direct challenges, arranged by date, to one or more of said fellow users.

7. The system of claim 1, wherein said application services interface further comprises a social reporting engine for collecting and storing user data in a user database, said user data comprising demographic facts and game-play behavior, for at least a first subset of said fellow users during a predetermined subset of interactions with said application services interface.

8. An interactive system for a plurality of game-like activities, said system comprising:
a content management system comprising a plurality of game templates, a game content database in communication with a plurality of external data services;
a plurality of application services, in communication with said content management system, comprising one or more game-like applications; and
one or more user interfaces to facilitate access to said plurality of application services for a plurality of users,
wherein said one or more game-like applications comprises said challenge application of claim 1.

9. The system of claim 8, further comprising a social reporting engine, in communication with said content management system, for collecting and storing user data in a user database, said user data comprising demographic facts and game-play behavior, for at least a first subset of said plurality of users during a predetermined subset of interactions with said plurality of application services.

10. The system of claim 1, wherein said processors of a computer system coupled to said non-transitory computer-readable medium further execute said program instructions to:
spot, by at least one of said first and said second competitors, a portion of the score prior to the collection by the external data reader.

11. A system for managing a lineup by a user of a fantasy game application, said system comprising:
an application services interface comprising a database and an external data reader in communication with a plurality of external data services;
a plurality of user interfaces to facilitate access to said application services interface; and
the fantasy game application comprising a non-transitory computer-readable medium containing program instructions for selecting an initial lineup of players in the fantasy game for accruing statistics in the fantasy game as indicated by the plurality of external data services, and one or more processors of a computer system coupled to said non-transitory computer-readable medium executing said program instructions to:
receive a request to modify at least one player in the initial lineup of players to a secondary player, after the at least one player selected for modification has begun to accrue the statistics in the fantasy game; by said first user for participation in a first direct challenge;
receive a timeframe for the request, wherein, during the requested timeframe, the secondary player and not the initial lineup player accrue the statistics in the fantasy game; and
grant the request by instructing by receiving from the external data services of the statistics for the secondary player and not the initial player during the timeframe.

12. The system of claim 11, wherein the secondary players are selected from a bench of players not in the initial lineup.

13. The system of claim 11, wherein the secondary players are selected from a free agent pool.
